(19) United States
(12) Patent Application Publication
(10) Pub. No.: US 2003/0092790 A1
(43) Pub. Date: May 15, 2003

(54) Photo-curable composition and the cured products

(76) Inventors: Yoshikazu Yamaguchi, Ibaraki (JP); Takao Yashiro, Kawaguchi (JP); Isao Nishiwaki, Toride (JP); Takashi Ukachi, Kamiya (JP)

Correspondence Address: PILLSBURY WINTHROP, LLP, P.O. BOX 10500, MCLEAN, VA, 22102, US

(21) Appl. No.: 10/184,014

(22) Filed: Jun. 28, 2002

Related U.S. Application Data
(63) Continuation of application No. PCT/NL00/00945, filed on Dec. 21, 2000.

(30) Foreign Application Priority Data
Dec. 28, 1999 (JP) 1999-373958

(51) Int. Cl. C08K 3/00

(52) U.S. Cl. 522/81

(57) ABSTRACT

The application relates to a photo-curable composition comprising: (A1) zirconium oxide particles or composite oxide particles containing zirconium and (B) a compound having two or more polymerizable unsaturated groups In the molecule, wherein the composition does not substantially contain a photo-radical polymerization initiator, and to cured products produced by curing the photocurable composition.

### FIELD OF THE INVENTION

The present invention relates to a photo-curable composition and a cured product made from the photo-curable composition. More particularly, the present invention relates to a photo-curable composition exhibiting excellent coatability and capable of forming coatings with high hardness and high refractive index on the surface of various substrates such as, for example, plastics (polycarbonate, polymethacrylate, polystyrene, polyester, polyolefin, epoxy resins, melamine resins, triacetyl cellulose resins, ABS resins, AS resins. norbomene resins, etc.), metals, woods, papers, glasses, and slates, as well as to cured products made therefrom The photo-curable composition and the cured product is suitable for use, for example, as a protective coating material to prevent stains or scratches on plastic optical parts, touch panels, film-type liquid crystal elements, plastic containers. or flooring materials, wall materials, and artifical marbles which are used for architectural interior finish, as an adhesive for various substrates, a sealing material, and a vehicle for printing ink; and the like.

### PRIOR ART

Among compositions applicable to the above-described objects which have been heretofore developed and put into use, the compositions curable by light (photo-curable compositions) or by electron beams (electron beam-curable compositions) are accepting wide popularity in recent years because of the high productivity and other reasons. To promptly and sufficiently cure such compositions by irradiation of lights, the use of a photo-radical initiator for photo-radical polymerization system and a photo-cationic initiator the photo-cationic polymerization system have been essential.

For example, Japanese Patent Publication No. 55307/1987 discloses a composition for a photocurable coating material comprising an acrylate and particles of colloidal silica of which the surface Is modified by methacryloxy silane, and the use α,α-diethoxyacetophonone as a photo-radical initiator. A feature of such a coating material is to improve performance (for example, scratch resistance, abrasion resistance, etc.) of the coating material by treating the surface of silica particles with a specific organic silane or under specific conditions.

However, in spite of some improvement in scratch resistance, abrasion resistance, etc., the photo-curable compositions (coating materials) in which particles are added have problems such as volatilization of part of photo-radical initiators during curing operation with lights, inadequate curing due to fouling of lamp, decrease in productivity, and the like.

### PROBLEMS TO BE SOLVED BY THE INVENTION

The present invention has been completed in view of the above-described problems and has an object of providing a photo-curable composition exhibiting excellent coatability and capable of forming coatings with high hardness and high refractive index in a high productivity without being affected by fouling of lamp, as well as the cured products made from the photo-curable composition.

### Means for Solving the Problems

Conventionally, a photo-radical initiator has been indispensable for curing a photo-curable composition containing a compound having a polymerizable unsaturated group. The inventor of the present invention has conducted extensive studies to achieve the above objectives and surprisingly has found that the problems can be solved by applying a photocurable composition (A1) zirconium oxide particles or composite oxide particles containing zirconium comprising a different metal (B) a compound having two or more polymerizable unsaturated groups in the molecule, wherein the composition does not substantially contain a photo-radical polymerization Initiator.

Preferred Embodiment of the Invention

The photo-curable composition and the cured products thereof of the present invention will now be described in more detail.

### II. Photo-curable Composition

The photo-curable composition of the present invention is a composition which comprises oxide particles (A1) and compound (B). but not substantially contains a photo-radical polymerization initiator (this composition may be hereinafter called “the first composition”).

The other photo-curable composition of the present invention is a composition which comprises reactive particles (A) and compound (B), but not substantially contains a photo-radical polymerization initiator (this composition may be hereinafter called “the second composition”).

The photo-curable composition of the present invention may further comprise (C) an organic solvent (hereinafter may be called “organic solvent (C)”).

1. First Composition

Each component for the first composition will be described in detail.

(1) Oxide Particles (A1)

The oxide particles (A1) used in the present invention are zirconium oxide particles or composite oxide particles containing zirconium.

Examples of such oxide particles (A1) are zirconia particles, zirconium-cerium composite oxide particles and zirconium-titanium-tin composite oxide particles. These compounds may be used either individually or in combination of two or more. The oxide particles (A1) ore preferably in the form of a powder or a solvent dispersion sol. When the oxide particles are in the form of a dispersion, an organic solvent is preferable as a dispersion medium from the viewpoint of mutual solubility with other components and dispersibility. Examples of such organic solvents are alcohols for example methanol, ethanol, isopropanol, butanol, and octanol, ketones such as for example acetone, methyl ketone, methyl isobutyl ketone, and cyclohexanone; esters such as for example ethyl acetate, butyl acetate, ethyl lactate, and γ-butyrolactone, propylene glycol monomethyl ether acetate, and propylene glycol monoethyl ether acetate; ethers such as for example ethylene glycol monomethyl ether and diethylene glycol mononbutyl ether; aromatic hydrocarbons such as for example benzene, toluene, and xylene; and amides such as for example dimethylformamide, dimethylacetamide, and N methylpyrrolidone. Preferably one or more of the organic solvents of the group consisting of methanol, isopropanol, butanol, methyl ethyl ketone, methyl isubutyl ketone, ethyl acetate, butyl acetate, toluene, and xylene are used.

The number average particle diameter of the oxide particles (A1) is from 0.001 μm to 2 μm, preferably from 0.001 μm to 0.2 μm, and more preferably from 0.001 μm to 0.1 μm. If the number average particle diameter is more than 2 μm, transparency of the cured product and surface conditions of the Coating tend to be impaired. Moreover, various surfactants and amines may be added to improve dispersibility of particles.

Examples of commercially available products of the oxide particles (A1) are toluene dispersion of zirconia particles such as “HXU-110JC” manufactured by Sumitomo Osaka Cement Co., Ltd. and composite oxide particles of zirconium-titanium-tin such as HII-30M manufactured by Nissan Chemical Industries, Ltd.

The shape of oxide particles (A1) may be globular, hollow, porous, rod-like, plate-like, tibrous, or amorphous, with a globular shape being preferable. The specific surface area of oxide particles (A1), determined by the BET method using nitrogen, is preferably in the range of 10 to 1000 m²/g, and more preferably 100 to 500 m^{2/}g. These oxide particles (A1) can be used either in the form of a dry powder or a dispersion in water or an organic solvent. For example, a dispersion liquid of fine particles of oxide known in the art as a solvent dispersion sol of these oxides can be used. Use of a solvent dispersion sol of oxide is particularly desirable in the application in which excellent transparency of cured products is required.

The oxide particles (A1) are Incorporated In an amount from 10-95 wt %, and preferably from 65-90. wt %. If less than 10 wt %, products with a high refractive index may not be obtained; if more than 95 wt %, film forming capability of the cured products may be inadequate. The amount of the oxide particles (A1) here means the amount of solid components and does not include the amount of solvents when the oxide particles (A1) are used in the form of a solvent dispersion sol.

(2) Compound (B)

The compound (B) is used in the first composition is a compound having two or more polymerizable unsaturated groups in the molecule. The compound (B) is preferably used to increase film-forming capability of the composition. Although there are no specific limitations to the types of compound (B) so long as the compound has two or more polymerizable unsaturated groups, compounds having three or more polymerizable unsaturated groups are more preferable. Compounds such as (meth)acrylic esters and vinyl compounds can be given as examples, with (meth)acrylic esters are more preferable.

The following compounds can be given as specific examples or the compound (B) used in the present invention.

Given as examples of (meth)acrylic esters are trimethylolpropane tri(meth)acrylate, ditrimethylolpropane tetra(meth)acrylate, pentaerythritol tri(meth)acrylate, pentaerythritol tetra(meth)acrylate, dipentaerythritol penta(meth)acrylate, dipentaerythritol hexa(meth)acrylate, glycerol tri(meth)acrylate. tris(2-hydroxyethyl) isocyanurate tri(meth)acrylate, ethylene glycol di(meth)acrylate, 1,3-butanediol di(meth)acrylate, 1,4-butanediol di(meth)acrylate, 1,6-hexanediol di(meth)acrylate, neopentyl glycol di(meth)acrylate, diethylene glycol di(meth)acrylate, triethylene glycol di(meth)acrylate, dipropylene glycol di(meth)acrylate, and bis(2-hydroxyethyl) isocyanurate di(meth)acrylate: as well as ethylene oxide or propylene oxide addition poly(meth)acrylates to these (meth)acrylates, oligoester (meth)acrylates, oligoether (meth)acrylates, oligourethane (meth)acrylates, and oligoepoxy (meth)acrylates having two or more (meth)acryloyl groups in the molecule, and the like. Among these, dipentaerythritol hexa(meth)acrylate, dipentaerythritol penta(meth)acrylate, pentaerythritol tri(meth)acrylate, pentaerythritol tetra(meth)acrylate, and ditrimethyolpropane tetra(meth)acrylate are most preferred.

Examples of vinyl compounds are divinylbenzene, ethylene glycol divinyl ether, diethylene glycol divinyl ether and triethylene glycol divinyl ether.

Examples of commercially available products of the compound (B) are the products having the trade names Aronix M-400, M-408, M-450, M-305, M-309, M-310, M-315, M-320, M-350, M-360, M-208, M-210, M-215, M-220, M-225, M-233, M-240, M-245, M-260, M-270, M-1100, M-1200, M-1210, M-1310, M-1600, M-221, M-203, TO-924, TO-1270, TO-1231, TO-595, TO-756, TO-1343, TO-902, TO-904, TO-905, and TO-1330 (manufactured by Toagosei Co., Ltd.); KAYARAD D-310, D-330, DPHA, DPCA-20, DPCA-30, DPCA-60, DPCA-120, DN-0075, DN-2475, SR-295, SR-355, SR-399E, SR-494, SR-9041, SR-368, SR-415, SR-444, SR-454, SR492, SR-490, SR-502, SR-9020, SR-9035, SR-111, SR-212, SR-213, SR-230, SR-259, SR-268, SR-272, SR-344, SR-349, SR-601, SR-602, SR-610, SR-9003, PET-30, T-1420, GPO-303, TC-120S, HDDA, NPGDA, TPGDA, PEG400DA, MANDA, HX-220, HX-620, R-551, R-712, R-167, R-526, R-551, R-712, R-604, R-684, TMPTA, THE-330, TPA-320, TPA-330, KS-HDDA, KS-TPGDA, KS-TMPTA (manufactured by Nippon Kayaku Co., Ltd.); and Light Acrylate PE-4A, DPE-6A, DTMP-4A (manufactured by Kyoeisha Chemical Co., Ltd.).

The amount of the compound (B) used in the first composition is preferably from 5-90 wt %. and more preferably from 10-35 wt %, for 100 wt % of the composition (the total of the oxide particles (A1) and the compound (B)). If the amount of compound (B) is less than 5 wt %, film forming capability of the cured products may be inadequate; if more than 90 wt %, products with am high refractive index may not be obtained.

If required, a compound having one polymerizable unsaturated group in the molecule may be used in first composition in addition to the compound (B).

(3) Photo-radical Initiator

The composition of the present invention does not substantially comprise a photo-radical initiator.

However, the addition of a photo-radical initiator in the amount of 1 wt % or less, and preferably 0.1 wt % or less, is acceptable to the extent that the effect of the present invention is not impaired. If the composition contains a photo-radical initiator, there will be the case where curing is insufficient due to fouling of lamp or productivity decreases when curing the composition.

4) Solvent (C)

The first composition of the photo-curable composition may contain an organic solvent (C), if required.

Although there are no specific limitations, the same solvent as used as a dispersion medium for the solvent dispersion sol of the oxide particles (A1). for example, can be used as the organic solvent (C).

The amount of organic solvent (C) added to the composition is preferably from 10-10,000 part by weight, and more preferably from 25-1,000 parts by weight, for 100 parts by weight of the composition (the total of the oxide particles (A1) and compound (B)). If less than 10 parts by weight, the composition may exhibit impaired storage stability, and if more than 10,000 parts by weight, it may be difficult to form coatings with desired thickness.

2. Second Composition

The second composition Is the same as the first composition, except for using reactive particles (A), which are the reaction product of oxide particles (A1) and an organic compound having a polymerizable unsaturated group (A2) (hereinafter called “organic compound (A2)”), instead of the oxide particles (A1) of the first composition. The method for the preparation of reactive particles (A) will now be described.

(1) Oxide Particles (A1)

The same oxide particles (A1) as used in the first composition (A1) can be used in the second composition.

(2)Organic compound (A2)

The organic compound (A2) used in the second composition is a compound having a polymerizable unsaturated group in the molecule, and preferably a specific organic compound comprising the group shown by the following formula (1), [—X—C (═Y)—NH—].

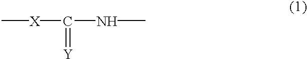

In addition, the organic compound preferably includes a group represented by [—O—C(—O) NH ] and at least one of the groups represented by [—O—C (═S)—NH—] or [—S—C(═O)—NH—]. It is particularly preferable that the organic compound (A2) have a silanol group or a group which forms a silanol group by hydrolysis in the molecule.

### (i) Polymerizable Unsaturated Group

There are no specific limitations to the polymerizable unsaturated groups included in the organic compound (A2). An acryloyl group, methacryloyl group, vinyl group, propenyl group, butadienyl group, styryl group, ethynyl group, cinnamoyl group, malate group, and acrylamide group, can be given as suitable examples.

This polymerizable unsaturated group Is a structural unit to effect an addition polymerization by active radicals.

### (ii) The Group Shown by the Above Formula (1)

There are 6 types for the group [—X—C (═Y)—NH—] of the formula (1) included in the second organic compound (A2), specifically, they are [—O—C (═O)—NH—], [—O—C(═S)—NH—], [—S—C(═O)—NH—]. [—NH—C(═O)—NH—], [—NH—C(═S)—NH—], and [—S—C(—S) NH ]. These groups may be used either individually or in combinations of two or more. Among these, the combined use of the group [—O—C(═O)—NH—] and either one or the groups [—O—C(—S)—NH—] and [—S—C(—O)—NH—] is preferable from the viewpoint of ensuring excellent heat stability.

The above-mentioned group [—X—C (═Y)—NH—] of the formula (1) is considered to generate a moderate cohesive force by a hydrogen bond among molecules, which provides the cured product with characteristics such as superior mechanical strength, excellent adhesion properties to substrates, and good heat resistance.

### (III) Silanol Group or a Group Which Forms a Silanol Group by Hydrolysis

The organic compound (A2) is preferably a compound having a silanol group (hereinafter may be called “silanol group-containing compound”) or a compound which forms a silanol group by hydrolysis (hereinafter may be called “silanol group-forming compound”). Examples of silanol group forming compounds are compounds having a Si atom that is at least partially substituted with an alkoxy group, aryloxy group, acetoxy group, amino group or halogen atom. A preferred silanol group forming compound is an alkoxysilyl group containing compound or an acyloxysilyl group containing compound.

The silanol group or the silanol group-forming site of the silanol group-forming compound is the structural unit which bonds with the oxide particles (A1) by a condensation reaction or the condensation reaction following hydrolysis.

### (iv) Preferable Embodiment

The compound shown by the following formula (2) can he given as a preferable specific example of the organic compound (A2).

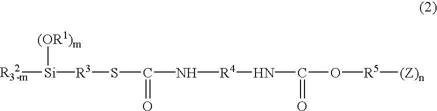

wherein R¹ and R² individually represent a hydrogen atom or an alkyl group having 1-8 carbon atoms such as a methyl group, ethyl group, propyl group, butyl group or octyl group, or an aryl group having 6-12 C-atoms for example a phenyl or xylyl group; R³ is a divalent organic group having a C₁-C₁₂ aliphatic (which may include a linear, branched, or cyclic structure) or aromatic structure; R⁴ is a divalent organic group and usually selected from the divalent organic groups having a molecular weight from 14 to 10,000, and preferably from 70 to 500, R⁵ is an organic group of a (n+1) valence and preferably selected from the group consisting of linear, branched, or cyclic, saturated or unsaturated hydrocarbon groups, R², R³, R⁴ and R⁵ may contain hetero atoms like for example O, N, S and P; Z is a monovalent organic group having a polymerizable unsaturated group in the molecule which causes an inter-cross-linking reaction In the presence of reactive radicals; wherein m is an integer from 1-3; n is an integer preferably from 1 to 20, and more preferably from 1 to 10, and most preferably from 1 to 5.

As examples of the group represented by [(R¹O)ₘR²₃₋ₘSi ], trimethoxy silyl group, triethoxy silyl group, triphenoxy silyl group, methyldimethoxy silyl group, dimethylmethoxy silyl group, and the like can be given. Of these groups, trimethoxysilyl group, triethoxysilyl group, and the like are desirable.

Examples of organic group Z are an acrylol group, methacryloyl group, vinyl group, propenylgroup, butadienyl group, styryl group, ethynyl group, cinnamoyl group, malate group and acrylamide group.

The second organic compound (A2) and the reactive. particles (A) used in the second composition can be prepared by a method described in Japanese Patent Application Laid-open No. 100111/1997, for example

The amount of the organic compound (A2) bonded to the oxide particles (A1) is preferably 0.01 wt % or more, more preferably 0.1 wt % or more, and particularly preferably 1 wt % or more, for 100 wt % of the reactive particles (A) (the total of oxide particles (A1) and organic compound (A2)). It the amount of the organic compound (A2) bonded to the oxide particles (A1) is less then 0.01 wt %, dispersibility of the reactive particles (A) in the resulting composition may be impaired and transparency and scratch resistance of the cured products may be insufficient. Moreover, the ratio of oxide particles (A1) in the raw materials in the preparation of the reactive particles (A) is preferably 5-99 wt %, and more preferably 10-98 wt %.

The reactive particles (A) are incorporated in the composition in an amount from 10-95 wt %, and preferably from 65-90 wt %. If less than 10 wt %, products with a high refractive index may not be obtained; if more than 95 wt %, film forming capability of the cured products may be inadequate.

The amount of oxide particles (A1) in the reactive particles (A) is preferably 65-90 wt % for 100 wt % of the composition.

The amount of the reactive particles (A) here means the amount of the solid components and does not Include the amount of solvents when the reactive particles (A) are used in the form of a solvent dispersion sol.

3. Method of Coating the Composition

The composition of the present invention is suitable as a coating material. Plastics (polycarbonate, polymethylene acrylate, polystyrene, polyester, polyolefin, epoxy, melamine, triacetyl cellulose, ABS, acrylonitrile-styrene resin, norbornene resin, etc.), metals, wood, papers, glasses, slates, and the like can be given as examples of the substrates to which the composition is coated. These substrates may be either in the shape of a film or a formed three-dimensional object. Conventional coating methods such as dipping, spray coating, flow coating, shower coating, roll coating, brush coating, and the like can be given as coating methods. The thickness of coating films after curing and drying is usually from 0.05 to 400 μm, and preferably from 1 to 200 μm.

To adjust the coating film thickness, the composition of the present Invention can be used by diluting with a solvent. When used as a coating material, for example, the viscosity of the composition is usually from 0.1 to 50,000 mPa·s/25° C., and preferably from 0.5 to 10,000 mPa·s/25° C.

4. Method of Curing the Composition

The composition of the present invention is cured by radiation (lights).

There are no specific limitations to the source of the radioactive rays so long as the composition can be cured in a short period of time after coating. As examples of the source of infrared rays, a lamp, resistance heating plate, laser, and the like can be given. As examples of the source of visible rays, sunlight, a lamp, fluorescent lamp, laser, and the like can be given. As the source of ultraviolet rays, a mercury lamp, halide lamp, laser, and the like can be given. As examples of the source of electron beams, a system of utilizing thermoelectrons produced by a commercially available tungsten filament, a cold cathode method generating electron beams by passing a high voltage pulse through a metal, and a secondary electron method which utilizes secondary electrons produced by collision of ionized gaseous molecules and a metal electrode can be given. As the source of α-rays, β-rays, and γ-rays, for example, fissionable materials such as Co⁶⁰ and the like can be given. These radioactive lays can be used either individually or in combinations of two or more. In the latter case, the two or radioactive lays may be used either simultaneously or with a certain intervals.

### II. Cured Products

The cured products of the present invention can be obtained by applying the composition onto a plastic substrate, for example, and curing the coating. Specifically, such a cured product can be obtained as a coated form by applying the composition onto an object, drying the coating by removing volatile components at a temperature preferably from 0 to 200° C., and curing the coating by radioactive rays. As radioactive rays, ultraviolet rays and electron beams are preferable. Ultraviolet rays are irradiated at a dose preferably from 0.01-10 J/cm², and more preferably from 0.1 to 2 J/cm². Electron beams are Irradiated under the conditions of 10-300 KV, an electron density of 0.02-0.30 mA/cm², and at a dose from 1-10 Mrad.

The refractive Index of the cured product is preferably 1.69 or more, and more preferably 1.71 or more.

Because the cured product of the present invention n excellent characteristics such as high hardness and high refractive index, the product is suitable for use as a protective coating material to prevent stains or scratches on plastic optical parts, touch panels, film-type liquid crystal elements, plastic containers, or flooring materials, wall materials, and artificial marbles which are used for architectural interior finish; as an adhesive for various substrates, a sealing material, and a vehicle for printing ink; and the like.

### EXAMPLES

The present invention will now be described in more detail by way of example, which should not be construed as limiting the present invention.

In the description below, “parts” and “%” respectively mean “parts by weight” and “wt %”, unless otherwise indicated.

The words “solid content” in the present invention means the content of components excluding volatile components such as solvents from the composition in the present invention, specifically, “solid content” means the content of a residue (nonvolatile components) obtained by drying the composition for one hour on a hot plate at 120° C.

Dispersion of Oxide Particles (A1) in Organic Solvents

### Dispersion Example 1

300 parts by weight of fine zirconia powder (manufactured by Sumitomo Osaka Cement Co., Ltd.) was added to 700 parts by weight of methyl ethyl ketone (MEK) and dispersed for 168 hours using glass beads. Glass beads were removed to obtain 950 parts by weight of zirconia dispersion sol in methyl ethyl ketone (A1-1). 2 g of the dispersion liquid was weighed on an aluminum dish and dried for one hour over a hot plate at 120° C. The dried material was weighed to indicate that the solid content was 30%. The specific surface area of the solid material measured by the BET method was 30 m^{2/}g and the calculated particle diameter was 31 nm.

### Dispersion Example 2

MIBK zirconia sol (A1-2) was prepared In the same manner as in Dispersion Example 1 except for using methyl isobutyl ketone (MIBK) instead of MEK. The content of the solid components in this dispersion liquid was measured In the same manner as in Dispersion Example 1, to indicate that the solid content was 30%. The specific surface area of the solid material measured by the BET method was 30 m²/g and the calculated particle diameter was 31 nm

### Dispersion Example 3

Toluene zirconia sol (A1-3) Was prepared in the same manner as in Dispersion Example 1 except for using toluene instead of MEK. The content of the solid components in this dispersion liquid was measured in the same manner as in Dispersion Example 1, to indicate that the solid content was 30%. The specific surface area of the solid material measured by the BET method was 30 m^{2/}g and the calculated particle diameter was 31 nm.

Synthesis of Organic Compound (A2)

### Synthetic Example 1

20.6 part of isophorone diisocyanate was added to a solution or 7.8 parts of mercaptopropyltrimethoxysilane and 0.2 port of dibutyl tin dilaurate in dry air in one hour while stirring at 5° C., The mixture was stirred for a further three hours at 60° C. After the addition of 71.4 parts of pentaerythritol triacylate dropwise in one hour at 30° C., the mixture was stirred for a further three hours at 60° C. with heating to obtain an organic compound (A2-1). The amount of isocyanate remaining in the product was analyzed to find that the remaining amount was 0.1% or less, indicating that the reaction was completed almost quantitatively.

Preparation of Reactive Particles (A)

Examples for preparing reactive particles (A) are shown in Preparation Examples 1 to 2. The results are summarized in Table 1.

### Preparation Example 1

A mixture of 8.2 parts of the organic compound (A2-1) synthesized in Synthetic Example 1, 91.8 parts of MEK zirconia sol(A1-1), 41.2 parts of MI-K, and 0.1 part of ion-exchanged water were stirred for 3 hours at 60° C. After the addition of 1 parts of methyl ortho-formate, the mixture was Stirred for a further one hour at the same temperature to obtain a dispersion sol (A-1) of reactive particles (A) % g of the dispersion sol (A-1) was weighed on an aluminum dish and dried for one hour over a hot plate at 120° C. The dried material was weighed to indicate that the solid content war 25%.

### Preparation Example 2

Dispersion sol (A-2) of reactive particles (A) was prepared in the same manner as in Dispersion Example 1 except for using toluene instead of MCK and using the toluene zirconia sol. The content of the solid components in this dispersion sol (A-2) was measured in the same manner as in Preparation Example 1, to indicate that the solid content was 25%.

TABLE 1

| | Preparation Example | |
|---|---|---|
| | 1 | 2 |
| Dispersion sol of reactive particles (A) | A-1 | A-2 |
| Oxide particle sol (A1) | | |
| A1-1 (Oxide concentration: 30%) | 91.8 | — |
| A1-3 (Oxide concentration: 30%) | — | 91.8 |
| Organic compound (A2) | 8.2 | 8.2 |
| A2-1 | | |
| Ion-exchanged water | 0.1 | 0.1 |
| Solvent | | |
| Methyl ethyl ketone | 41.2 | — |
| Toluene | — | 41.2 |
| Methyl ortho-formate | 1.3 | 1.3 |
| Solid content (%) | 25 | 25 |
| Percentage of oxide particles in solid components | 77 | 77 |

### Examples for the Preparation of Compositions

Examples for the preparation of the composition of the present invention are shown in Examples 1-8 and Comparative Examples 1-2. The weight ratio to of the components for the compositions are shown in Table 2.

### Example 1

A mixture of 267 parts (80 parts of zirconia particles and 187 parts of dispersion medium MEK) of dispersion sol (A1-1) and 20 parts of dipentaerythritol hexaacylate was stirred for two hours at 50° C. to obtain a homogeneous liquid composition. The solid content of the composition was determined in the same manner as in Preparation Example 1, to find that the solid content was 35%.

### Examples 2-8

Compositions for Examples 2-8 were prepared in the same manner as in Example 1 except fur using the components shown In Table 2.

### Comparative Example 1

A mixture of 267 parts (80 parts of zirconia particleses and 187 parts of dispersion medium MEK) of dispersion sol (A1-1), 20 parts of dipentaerythritol hexaacylate, 1.5 parts of 1-hydroxycyclohexyl phenyl ketone, and 3.5 parts of 2,2-diethoxy acetophenone was stirred for two hours at 50° C. to obtain a homogeneous liquid composition. The solid content of the composition was determined in the same manner as in Preparation Example 1, to find that the solid content was 36%.

### Comparative Examples 2-3

Compositions of Comparative Example 2-3 was prepared in the same manner as in Example 1 except for using the components shown in Table 2.

Evaluation of Cured Products

To demonstrate the effects of the composition of the present invention, the cured products obtained from the above-mentioned compositions by coating, drying, and exposure to radiation were evaluated. The cured products were evaluated according to the following methods. The results of the evaluation are shown in Table 2.

Evaluation Methods

Pencil hardness:

The compositions were applied to glass substrates using a bar coater so as to produce dry films with a thickness of 10 μm, dried in a hot oven at 80° C. for 3 minutes, irradiated at a dose of 1 J/cm² using a conveyer-type mercury lamp to obtain cured coatings. Cured coatings were allowed to leave at 25° C. for 24 hours and evaluated according to JIS K5400

Refractive index;

A mixture of 100 parts of dipentaerythritol hexacrylate or pentaerythritol triacylate. 2 parts of hydroxycyclohexyl phenyl ketone, and 187 parts of MEK was coated on the above-described glass substrate, dried, and cured under the above-described conditions. After peeling off from the glass substrate, the refractive index of the coating film was determined using Abbe refractometer to confirm that the refractive index of either mixture (the mixture using dipentaerythritol hexacrylate or pentaerythritol triacylate) was 1.53.

Using the measured refractive index, the refractive index of tile cured product of the present invention was calculated according to the following formula.

Refractive index of the cured product=(refractive Index of zirconia (2,05)×volumetric fraction of zirconia) −1 (refractive index of compound (B) (1.53)×volumetric fraction of compound (B))

The zirconia density of 5.49 g/cm³ and the density of compound (B) of 1.19 g/cm³ were used for the calculation of volumetric fractions.

Lamp fouling resistance:

The compositions were applied to polyethylene terephthalate (PET) film substrates with a thickness of 188 μm using a bar coater to produce dry coatings with a thickness of 10 μm. The coatings were dried in a hot oven at 80° C. for 3 minutes placed in a tightly sealed box with a height of 1 cm, of which the upper surface is made of quartz, and irradiated with light at a dose of 1 J/cm² using a conveyer-type mercury lamp. After curing, cloudiness of quartz was visually inspected to evaluated the lamp fouling resistance. Specimens with no cloudiness of quartz was rated as AAA, with slight cloudiness of quart was rated as BBB, and with cloudiness of quartz was rated as CCC.

TABLE 2

| | Example | | | | | | | | Comparative Example | | |
|---|---|---|---|---|---|---|---|---|---|---|---|
| | 1 | 2 | 3 | 4 | 5 | 6 | 7 | 8 | 1 | 2 | 3 |
| Oxide particles (A1)* | | | | | | | | | | | |
| A1-1 | 80 | 70 | — | — | — | — | — | — | 80 | — | — |
| A1-2 | — | — | 70 | — | — | — | — | — | — | — | — |
| A1-3 | — | — | — | 70 | 70 | — | — | — | — | — | — |
| Reactive particles (A)* | | | | | | | | | | | |
| A-1 | — | — | — | — | — | 92 | 98 | — | — | — | — |
| A-2 | — | — | — | — | — | — | — | 92 | — | — | — |
| Silica particles (AS)* | — | — | — | — | — | — | — | — | — | — | 80 |
| AS-* | | | | | | | | | | | |
| Acrylic esters (B) | | | | | | | | | | | |
| B1 | 20 | 30 | 30 | 30 | — | 8 | 2 | 8 | 20 | 100 | 20 |
| B2 | — | — | — | — | 30 | — | — | — | — | — | — |
| Radical initiator | | | | | | | | | | | |
| R1 | — | — | — | — | — | — | — | 1.5 | 2.0 | — | |
| R2 | — | — | — | — | — | — | — | — | 3.5 | — | — |
| Organic solvent | | | | | | | | | | | |
| MEK | 187 | 163 | — | — | — | 276 | 294 | — | 187 | 187 | 187 |
| MIBK | — | — | 163 | — | — | — | — | — | — | — | — |
| Toluene | — | — | — | 163 | 163 | — | — | 276 | — | — | — |
| Total | 287 | 263 | 263 | 263 | 263 | 376 | 394 | 376 | 292 | 289 | 287 |
| Solid content (%) | 35 | 38 | 38 | 38 | 38 | 27 | 25 | 27 | 36 | 35 | 35 |
| Oxide particles in solid components (%) | 80 | 70 | 70 | 70 | 70 | 70 | 75 | 70 | 76 | 0 | 80 |
| Cured product properties | | | | | | | | | | | ** |
| Penci. hardness | 8H | 8H | 8H | 8H | 8H | 8H | 8H | 8H | 8H | 7H | — |
| Refractive Index | 1.77 | 1.71 | 1.71 | 1.71 | 1.71 | 1.71 | 1.74 | 1.71 | 1.74 | 1.53 | — |
| Lamp fouling resistance | AAA | AAA | AAA | AAA | AAA | AAA | AAA | AAA | CCC | AAA | — |

**The composition did not cure

In Table 2. asterisks (*) for oxide particles (A1), reactive particles (A), silica particles (AS) indicate the weight of particles (excluding organic solvents) in each dispersion sol added.

Abbreviations in Table 2 have the following meanings.

AS-1; Methyl ethyl ketone silica sol (solid content: 30%, MEK-ST manufactured by Nissan Chemical Industries, Ltd)

C1: Dipentaerythritol hexaacrylate

B2: Pentaerythritol triacylate

R1: 1-Hydroxycyclohexyl phenyl ketone

R2: α,α-Diethoxyacctophenone

Effect of the Invention

As described above. the present invention provides a photo-curable composition exhibiting excellent coatability and capable of forming coatings with high hardness and high refractive index in a high productivity without being affected by fouling of lamp, as well as the cured products made from the photo-curable composition.

1. A photo-curable composition comprising:
(A1) zirconium oxide particles or composite oxide particles containing Zirconium and a different metal
(B) a compound having two or more polymerizable unsaturated groups in the molecule,
wherein the composition does not substantially contain a photo-radical polymerization Initiator.

2. A photo-curable composition comprising:
(A) particles prepared by bonding (A1) zirconium oxide particles or composite oxide particles containing zirconium with (A2) an organic compound having a polymerizable unsaturated group, and
(B) a compound having two or more polymerizable unsaturated groups in the molecule,
wherein the composition does not substantially contain a photo-radical polymerization initiator.

3. The photo-curable composition according to claim 1 or claim 2, wherein the component (B) is at least one compound selected from the group consisting of dipentaerythritol hexa(meth)acrylate, dipentaerythritol penta(meth)acrylate, pentaerythritol tri(meth)acrylate, pentaerythritol tetra(meth)acrylate, and ditrimethylolpropane tetra(meth)acrylate.

4. The photo-curable composition according to any one of claims 1-3, further comprising (C) an organic solvent.

5. A cured product produced by curing the photo-curable composition according to any one of claims 1 to 4.

6. The cured product according to claim 5, having a refractive index of 1.69 or more.
